(19) United States
(12) Patent Application Publication
(10) Pub. No.: US 2011/0087351 A1
(43) Pub. Date: Apr. 14, 2011

(54) CUSTOMIZED ARTIFICIAL NAIL

(76) Inventors: Rohit Sachdeva, Plano, TX (US); Maya Sachdeva, Plano, TX (US); Nikita Sachdeva, Plano, TX (US); Arjun Sachdeva, Plano, TX (US)

(21) Appl. No.: 12/576,406

(22) Filed: Oct. 9, 2009

(51) Int. Cl. G05B 19/4097; G06F 17/50

(52) U.S. Cl. 700/98; 700/118

(57) ABSTRACT

Method and system for designing and making one or more artificial nails customized to fit one or more real nails of a client are disclosed. Additionally, the invention enables customization or selection of decorative patterns for the artificial nail. The process begins with scanning one or more nails of the client with a scanner. The scanned image is then converted into a virtual three-dimensional surface model for each real nail. The virtual three-dimensional model of each nail is displayed on a monitor of a workstation. The user, e.g. a beautician at a beauty saloon, using the workstation and in consultation with the client, designs a customized artificial nail using the virtual three-dimensional model of the real nail. At the user command, the customized design of the artificial nail is then sent to a numerically controlled (NC) or a similar machine, where the artificial nail is made in accordance with the custom design. The artificial nail may be made from acrylic materials or other suitable materials.

### BACKGROUND OF THE INVENTION

A. Field of the Invention

This invention pertains to a method and system for designing and making one or more artificial nails customized to fit one or more real nails of a client. Additionally, the invention enables customization or selection of decorative shapes and patterns for the artificial nail. Furthermore, the invention discloses decorating nails with laser etching, photo printing, and stencil and spray painting.

B. Description of Related Art

The industry for artificial nails is booming. Almost every shopping area has a beauty saloon catering to providing, among other beauty related services, artificial or false nails to its customers. In large part, people, especially women, desire artificial nails for decorative and fashionable looks. However, often artificial nails are used to remedy nail biting and chewing habits; or to cover-up damaged or diseased nails. The artificial nail may cover the entire real nail or it may cover a portion of the real nail such as the nail tip. In general, the artificial nails are typically made from acrylic materials, and come in stocks, commonly referred to as nail tips, offered in various standard sizes, decorative designs and colors. So for a client, a nail tip with the best fit to the natural nail shape is chosen. However, the standard-size, best-fit artificial nail may not truly be a well desired fit to the natural nail from the perspective of natural nail surface anomalies, shape of the cuticle, the nail sides, the nail front, and overall length and appearance. The artificial nail placement process generally requires manual filing and bending of the artificial nail by the saloon beautician in order to improve the fit. As noted above, generally the client is limited to selecting the decorative designs and colors for the artificial nails from the standard stock available at the beauty saloon. What is lacking in the art is to provide a truly customized artificial nail for a client. What is further lacking in the art is to provide a client the capability to design a decorative pattern, which may include different colors, for the artificial nail; or to select the decorative design from a vast collection not limited to the particular beauty saloon; or to select the appropriate material; or to match the nails with their costumes or jewelry.

The instant invention disclosed herein provides a method and system for designing and making one or more artificial nails customized to fit one or more real nails of a client. Additionally, the invention enables customization or selection of decorative patterns for the artificial nail.

### SUMMARY OF THE INVENTION

In the first aspect of the invention, a method and system are disclosed for designing and making one or more artificial nails customized to fit one or more real nails of a client. The process begins with scanning one or more nails of the client with a scanner. The nail may be scanned alone or with the surrounding skin tissues. If the nail is scanned with the surrounding skin tissues, then the nail image is digitally separated from the surrounding tissues in order to create the desired image of the virtual nail. The scanning may be performed at a beauty saloon. The scanner may be a white light scanner, a laser scanner, or any other scanning device. Alternately, the virtual image of the nail can be constructed from stereo photographic views of the nail. The image of the nail can also be created by first taking a negative impression or mold of the nail, and then scanning the mold to create a positive image of the nail; or by first creating a positive mold and then scanning the positive mold to create the image of the nail. The scanned image is converted into a virtual three-dimensional surface model for each nail. The virtual three-dimensional model of each nail is displayed on a monitor of a workstation also having a processing unit, memory and one or more storage devices. The user, e.g. a beautician at a beauty saloon, using the workstation and in consultation with the client, designs a customized artificial nail using the virtual three-dimensional model of the nail. The artificial nail so customized provides the best fit to the real nail in terms of the nail surface, shape of the artificial nail adjoining the cuticle, the sides, the length and the overall shape. At the user command, the customized design of the artificial nail is then sent to a numerically controlled (NC) or a similar machine, where the artificial nail is made in accordance with the custom design. Alternately, the nail can be cut from stock material with laser or electric discharge in accordance with the customized design. The nail can also be made from the mold. Alternately, the standard stock nails can be modified by adding or subtracting to match the customized artificial nail design. The artificial nail may be made from acrylic materials or other suitable materials. Additionally, the materials for the artificial nails may be selected based upon functionality, strength, or biocompatibility.

In yet another aspect of the invention, with proper computer and internet access, the nails can also be designed at home or in association with artists and friends. In another aspect of the invention, the custom design of the artificial nail is extended to include creation of a custom pattern and/or shape, which may include chosen colors, in consultation with the client. In yet another aspect of the invention, the user displays a variety of pattern designs selected from the database in the workstation on the workstation monitor in conjunction with the artificial nail and makes a selection of a pattern to be placed on the visible surface of the artificial nail in consultation with the client. In either case, the custom artificial nail with the selected pattern is then manufactured by a computer driven machine. In yet another aspect of the invention, various patterns can be laser etched or printed on the artificial nail, or stencils can be made to spray paint or mask previous patterns on the artificial nail. Alternately, gold or diamond coatings can b placed on the artificial nail by various coating approaches such as plasma vapor deposition or ion implantation, and, when desired, serial numbers can be etched on the artificial nail for identification.

Indeed the scanner can be placed anywhere; and the virtual images of the nails can be quickly delivered or made available wherever they are needed. Alternately, the nail design workstation can also be interfaced with clothing and jewelry stores to choose the right color pattern to meet jewelry and costume needs of the client. Nail design patterns can be defined for special occasions; such as Christmas etc. The artificial nails can be ordered with other cosmetics and with personalized kit. Furthermore, reminders for changing the artificial nail for a client can be prompted by the nail design workstation, and sent periodically to the clients. Quick replacement service can be provided. Additionally, the artificial nail designs can be matched to contact lenses, spectacles, etc. Miniaturized photographic images of one or more family members can be etched on the artificial nail. Signature series artificial nails which are for single user can be also be made

In yet another aspect of the invention a layer of glue is applied to the bottom surface of the artificial nail which will come in contact of the top surface of the real nail. In one aspect, the glue is cured by UV rays once the artificial nail is attached to the real nail. In yet another aspect, the glue is such that the artificial nail can be repeatedly attached to and removed from the real nail as desired. For example, a woman may wish to wear artificial nails to a party, and then remove them after coming home from the party; and reuse them in a similar fashion. Glue choice can be made based upon ease of removal or working conditions.

In one aspect, the machine making the custom artificial nail is co-located with the scanning device. In another aspect, the machine making the custom artificial nail is located at a location remote from the scanning device and is connected with the scanning station via a communication medium, such as a telecommunication network or an internet.

In the event that the nail is missing, damaged or disfigured, the scanning can be done of the surface area to the extent possible; and the artificial nail can be designed to realize the best fit.

Although the foregoing discussion focused on human client, one skilled in the art would appreciate that the artificial nails can also be made for dolls or pets using the processes and apparatus described above.

### BRIEF DESCRIPTION OF THE DRAWINGS

FIG. 1 illustrates a schematic block diagram of a typical customized artificial nail designing and making system, according to a preferred embodiment of the invention.

FIG. 2A shows a scanned image obtained from scanning a thumb with nail and surrounding skin of a client, according to a preferred embodiment of the invention.

FIG. 2B shows a virtual three-dimensional model of the thumb nail obtained from the scanned image of FIG. 2A by separating the nail from the surrounding skin tissue, according to a preferred embodiment of the invention.

FIG. 2C is an illustration of the design of a customized artificial nail based on the virtual three-dimensional nail model shown in FIG. 2B, according to a preferred embodiment of the invention.

FIG. 2D is an illustration of the artificial nail design shown in FIG. 2C with a pattern selected by the client placed on the visible surface of the artificial nail, according to a preferred embodiment of the invention.

FIG. 3A is an illustration of the custom artificial nail made by the NC machine based on the design illustrated in FIG. 2C, according to the preferred embodiment of the invention.

FIG. 3B is an illustration of the custom artificial nail made by the NC machine based on the design illustrated in FIG. 2D, according to the preferred embodiment of the invention.

### DETAILED DESCRIPTION OF PREFERRED EMBODIMENT

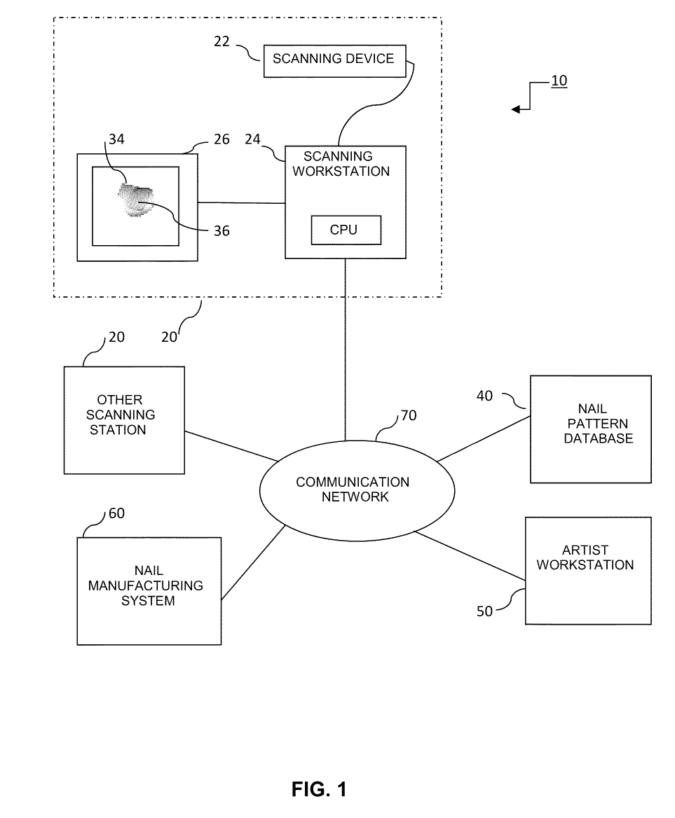

Generally, the present invention provides a method and system for designing and making one or more artificial nails customized to fit one or more real nails of a client. The process begins with scanning one or more nails of the client with a scanner. The scanner may be a white light scanner, a laser scanner, or any other scanning device. The scanned image is then converted into a virtual three-dimensional surface model for each real nail. The scanning may be performed at a beauty saloon. The virtual three-dimensional model of each nail is displayed on a monitor of a workstation also having a processing unit, memory and one or more storage devices. The user, e.g. a beautician at a beauty saloon, using the workstation and in consultation with the client, designs a customized artificial nail using the virtual three-dimensional model of the real nail. The artificial nail so customized provides the best fit to the real nail in terms of the nail surface, shape of the artificial nail adjoining the cuticle, the sides, the length and the overall shape. At the user command, the customized design of the artificial nail is then sent to a numerically controlled (NC) or a similar machine, where the artificial nail is made in accordance with the custom design. The artificial nail may be made from acrylic materials or other suitable materials. The present invention will be more fully described with the help of FIGS. 1 through 6.

FIG. 1 illustrates a schematic block diagram of a typical customized artificial nail designing and making system 10. The system 10 incorporates a scanning station 20 comprising a scanner 22 connected to a scanning workstation 24. The workstation 24 comprises a CPU or a processor, memory, digital storage devices and a monitor 26. The process starts with scanning one or more nails alone or with surrounding skin tissues of a client. For illustration purposes, a client's thumb is scanned by a user, such as a beautician or a technician at a nail salon, using the scanner 22, and the scanned image 34 is displayed on the monitor 26. When the nail is scanned with the surrounding skin tissues, the scanning workstation separates the virtual nail or the digital model of the nail 36 from the scanned image 34. The virtual nail 36 has three-dimensional surface contour modeled from the actual nail of the client. The scanning workstation 24 enables the user in designing the artificial nail, not shown in FIG. 1 for the sake of simplicity, from the virtual nail model 36. The design is displayed on the monitor 26, and according to one embodiment of the invention, is arrived at in consultation with the client. Alternately, a nail pattern database 40, which is connected with the scanning workstation 24 through a communication network 70, is accessed by the user for aid in designing the artificial nail. Alternately, the user may consult with an artificial nail artist through the artist workstation 50 and connected with the workstation 24 via the communication network 70, for designing the artificial nail. Once the artificial nail is designed, the scanning workstation 24 sends the design to the nail manufacturing system 60, which is also connected with the workstation 24 via the communication network 70. The nail manufacturing system makes the artificial nail in accordance with the design received from the workstation 24. Once the artificial nail is produced, it is shipped to the beauty salon or the client as appropriate. According to an embodiment of the invention, the scanning station may be housed at a beauty salon. In this arrangement, one skilled in the art would appreciate that, one or more beauty salons may share the nail pattern database 40, the nail artist through the artist workstation 50, the nail manufacturing system 60, etc. through the communication network 70. Indeed, although not shown in FIG. 1, it can be easily generalized that, there may be more than one nail pattern database 40, the nail artist work stations 50 with associated artists, the nail manufacturing system 60, etc. accessible to the user through the workstation 24 and the communication network 70. The scanner 22 may be a hand-held white light scanner. Alternately, the scanner may be a laser scanner, or any other scanning device. The scanning may be done one nail at a time or multiple nails may be scanned at the same time. Without the loss of generality, the nails scanned may be finger nails or toe nails.

Alternately, the virtual image of the nail can be constructed from stereo photographic views of the nail. The image of the nail can also be created by first taking a negative impression or mold of the nail, and then scanning the mold to create a positive image of the nail; or by first creating a positive mold and then scanning the positive mold to create the image of the nail.

According to an alternate embodiment of the invention, any combination of the nail pattern database 40, the nail artist workstation 50, and the nail manufacturing system 60, etc. may be housed together at a beauty salon.

The communication network 70 may be an Internet or any other communication medium, including private communication links, enabling the desired communications between the entities connected therein.

In one embodiment of the invention, the nail manufacturing system 60 makes the artificial nail as a plain stock without the patterns; whereby the user subsequently places the pattern on the plain stock of the artificial nail. In yet another embodiment of the invention, the nail manufacturing system 60 makes the artificial nail with a part of the desired pattern placed on the artificial nail; whereas the rest of the pattern is subsequently placed by the user on the artificial nail made by the nail manufacturing system 60. In yet another embodiment of the invention, the entire artificial nail with the desired pattern is made by the nail manufacturing system 60.

In one embodiment of the invention, the artificial nail manufacturing system 60 comprises Numerically Controlled (NC) machines. In yet another embodiment of the invention, the artificial nail manufacturing system 60 comprises a molding device.

Alternately, the nail can be cut from stock material with laser or electric discharge in accordance with the customized design. The nail can also be made from the mold. Alternately, the standard stock nails can be modified by adding or subtracting to match the customized artificial nail design. The artificial nail may be made from acrylic materials or other suitable materials. Additionally, the materials for the artificial nails may be selected based upon functionality, strength, or biocompatibility.

In yet another aspect of the invention, with proper computer and internet access, the nails can also be designed at home or in association with artists and friends. In another aspect of the invention, the custom design of the artificial nail is extended to include creation of a custom pattern and/or shape, which may include chosen colors, in consultation with the client. In yet another aspect of the invention, the user displays a variety of pattern designs selected from the database in the workstation on the workstation monitor in conjunction with the artificial nail and makes a selection of a pattern to be placed on the visible surface of the artificial nail in consultation with the client. In either case, the custom artificial nail with the selected pattern is then manufactured by a computer driven machine. In yet another aspect of the invention, various patterns can be laser etched or printed on the artificial nail, or stencils can be made to spray paint or mask previous patterns on the artificial nail. Alternately, gold or diamond coatings can b placed on the artificial nail by various coating approaches such as plasma vapor deposition or ion implantation, and, when desired, serial numbers can be etched on the artificial nail for identification.

Indeed the scanner can be placed anywhere; and the virtual images of the nails can be quickly delivered or made available wherever they are needed. Alternately, the nail design workstation can also be interfaced with clothing and jewelry stores to choose the right color pattern to meet jewelry and costume needs of the client. Nail design patterns can be defined for special occasions; such as Christmas etc. The artificial nails can be ordered with other cosmetics and with personalized kit. Furthermore, reminders for changing the artificial nail for a client can be prompted by the nail design workstation, and sent periodically to the clients. Quick replacement service can be provided. Additionally, the artificial nail designs can be matched to contact lenses, spectacles, etc. Miniaturized photographic images of one or more family members can be etched on the artificial nail. Signature series artificial nails which are for single user can be also be made.

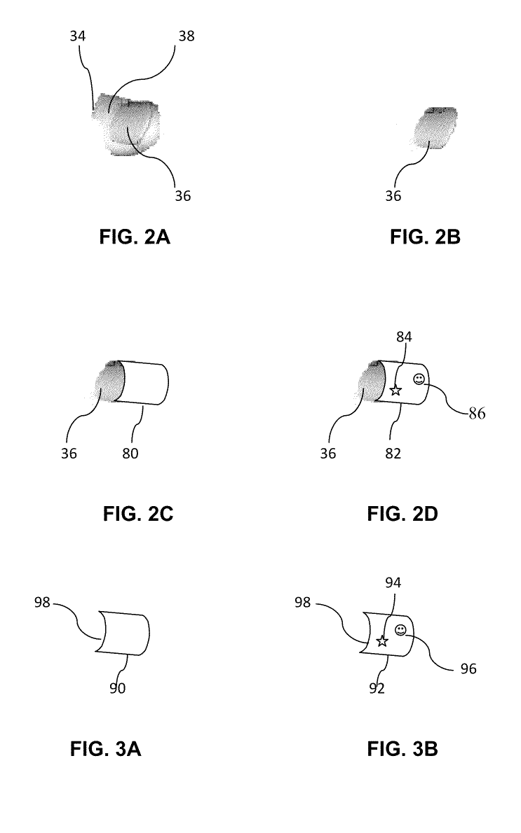

FIG. 2A shows, in an enlarged form, the scanned image of the thumb 34 shown in FIG. 1. As described above with reference to FIG. 1, image 34 is obtained from scanning a thumb with nail 36 and surrounding skin tissue 38 of a client using the scanner 22 shown in FIG. 1.

FIG. 2B shows the virtual three-dimensional model of the thumb nail 36 shown in FIG. 2A separated from the surrounding skin tissue 38 in FIG. 2A, using software instructions provided in the workstation 24 shown in FIG. 1. The virtual three-dimensional model of nail 36 retains the surface contour of the original nail; thus enabling accurate customization of the artificial nail.

Alternately, just the three-dimensional model of thumb nail 36 as shown in FIG. 2B could have been scanned, thus avoiding the need to separate it from the surrounding skin tissue.

FIG. 2C is an illustration of the design of a customized artificial nail 80, super imposed on the scanned image of the thumb nail 36, based on the virtual three-dimensional nail model 36 shown in FIG. 2B. The design is realized through a number of software tools available at the workstation 24 shown in FIG. 1. The user, e.g. a beautician at a beauty saloon, using the workstation 24 and in consultation with the client, designs a customized artificial nail using the virtual three-dimensional model of the real nail. The artificial nail so customized provides the best fit to the real nail in terms of the nail surface, shape of the artificial nail adjoining the cuticle, the sides, the length and the overall shape. In the embodiment where the nail artist using the workstation 50 is participating in the design of the artificial nail, there are a number of software tools also available at the workstation 50. These software tools include, for example, the artificial nail alignment, shaping, sizing and cutting tools.

FIG. 2D is an illustration of the artificial nail design 82, which comprises the artificial nail design 80 shown in FIG. 2C, with a pattern 84 and 86 selected by the client placed on the visible surface of the artificial nail. In another aspect of the invention, the custom design of the artificial nail is extended to include creation of a custom pattern, which may include chosen colors, in consultation with the client. In yet another aspect of the invention, the user displays a variety of pattern designs selected from the database in the workstation on the workstation monitor in conjunction with the artificial nail and makes a selection of a pattern to be placed on the visible surface of the artificial nail in consultation with the client.

FIG. 3A is an illustration of the custom artificial nail 90 made by the NC machine based on the design 80 shown in FIG. 2C, according to the preferred embodiment of the invention. At the user command, the customized design of the artificial nail is then sent to a numerically controlled (NC) or a similar machine, where the artificial nail is made in accordance with the custom design. The artificial nail may be made from acrylic materials or other suitable materials. In either case, the custom artificial nail with the selected pattern is then manufactured by a computer driven machine.

Similarly, FIG. 3B is an illustration of the custom artificial nail 92 made by the NC machine based on the design 82 shown in FIG. 2D, according to the preferred embodiment of the invention. Patterns 94 and 96 on the custom artificial nail 92 correspond to the design patterns 84 and 86, respectively, shown in FIG. 2D.

In yet another aspect of the invention, as shown in FIGS. 3A and 3B, a layer of glue 98 is optionally applied to the bottom surface of the artificial nail which will come in contact of the top surface of the real nail. In one aspect, the glue is cured by UV rays once the artificial nail is attached to the real nail. In yet another aspect, the glue is such that the artificial nail can be repeatedly attached to and removed from the real nail as desired. For example, a woman may wish to wear artificial nails to a party, and then remove them after coming home from the party; and reuse them in a similar fashion. Glue choice can be made based upon ease of removal or working conditions. In one aspect, the machine making the custom artificial nail is co-located with the scanning device. In another aspect, the machine making the custom artificial nail is located at a location remote from the scanning device and is connected with the scanning station via a communication medium, such as a telecommunication network or an internet.

In the event that a nail is missing, damaged or disfigured, the scanning can be done of the surface area to the extent possible; and the artificial nail can be designed to realize the best fit.

One skilled in the art would appreciate that entire hand or a foot of a client can be scanned along with the nails; and the artificial nails once designed can be displayed on the entire hand or the foot on the workstation to give the client an idea as to how the hand or the foot would look with the artificial nails; thus enabling desired changes in the artificial nail design prior to actually making the artificial nails.

Although the foregoing discussion focused on human client, one skilled in the art would appreciate that the artificial nails can also be made for dolls or pets using the processes and apparatus described above.

We claim:

1. A method for designing a customized artificial nail using a workstation, comprising the steps of:
obtaining a virtual three-dimensional image of a nail of a client; and
designing an artificial nail from said virtual three-dimensional image of said nail.

2. The method of claim 1, wherein said virtual three-dimensional image of said nail is created by scanning said nail by a scanner.

3. The method of claim 2, wherein said scanner is a hand held scanner.

4. The method of claim 2, wherein said scanner is a laser scanner.

5. The method of claim 1, wherein said artificial nail includes one or more patterns and/or one or more colors placed on the artificial nail.

6. The method of claim 5, wherein said one or more patterns are obtained from a database of patterns.

7. The method of claim 5, wherein said design of the artificial nail is done with the help of an artist.

8. The method of claim 1, further comprising the step of making said artificial nail using a numerically controlled machine.

9. The method of claim 1, further comprising the step of making said artificial nail from acrylic materials.

10. The method of claim 8, wherein a layer of glue is applied to the bottom surface of said artificial nail.

11. A system for designing a customized artificial nail, comprising:
a scanner for scanning a virtual three-dimensional image of a nail of a client; and
a workstation for designing an artificial nail from said virtual three-dimensional image of said nail; wherein said workstation is connected with said scanner.

12. The system of claim 11, wherein said scanner is a hand held scanner.

13. The system of claim 11, wherein said scanner is a laser scanner.

14. The system of claim 11, further comprising one or more databases of patterns;
wherein said one or more databases are connected with said workstation via a communication network.

15. The system of claim 14, wherein said artificial nail includes one or more patterns and/or one or more colors placed on the artificial nail; wherein said one or more patterns are obtained from said one or more databases of patterns.

16. The system of claim 11, wherein the design of said artificial nail is done with the help of an artist.

17. The system of claim 11, further comprising a numerically controlled machine;
wherein said numerically controlled machine is connected with said workstation via a communication network.

18. The system of claim 17, wherein said artificial nail is made using said numerically controlled machine.

19. The system of claim 17, wherein said artificial nail is made from acrylic materials.

20. The system of claim 18, wherein a layer of glue is applied to the bottom surface of said artificial nail.
